(19) United States
(12) Patent Application Publication
(10) Pub. No.: US 2025/0077318 A1
(43) Pub. Date: Mar. 6, 2025

(54) METHOD FOR SHARING DATA BETWEEN CROSS-END CONTAINER AND NATIVE RUNTIME ENVIRONMENT, DEVICE AND MEDIUM

(71) Applicant: Lemon Inc., Grand Cayman (KY)

(72) Inventors: Hua LIU, Beijing (CN); Yueyue XIONG, Beijing (CN)

(21) Appl. No.: 18/818,440

(22) Filed: Aug. 28, 2024

(30) Foreign Application Priority Data
Aug. 28, 2023 (CN) 202311095318.8

(51) Int. Cl. G06F 9/54

(52) U.S. Cl. CPC G06F 9/544

(57) ABSTRACT

The embodiments of the present disclosure describe a method for sharing data between a cross-end container and a native runtime environment, a device and a medium. And the method includes: acquiring or updating, by the cross-end container or the native runtime environment, target data, and saving the target data to a shared storage region in the native runtime environment respectively in a first data format corresponding to the cross-end container and a second data format corresponding to the native runtime environment; and accessing, by the native runtime environment or the cross-end container, the shared storage region, and reading the target data in the second data format or the first data format respectively corresponding to the native runtime environment or the cross-end container.

### CROSS-REFERENCE TO RELATED APPLICATION

The present application claims the priority and benefits of Chinese Patent Application No. 202311095318.8, filed on Aug. 28, 2023, which is incorporated herein by reference in its entirety as part of the present application.

### TECHNICAL FIELD

Embodiments of the present disclosure relate to a field of cross-end container technology, and more particularly, to a method and apparatus for sharing data between a cross-end container and a native runtime environment, and a device.

### BACKGROUND

A cross-end container, or say, a cross-end runtime environment, is a technology that allows a user to write a set of codes to run on a variety of terminals. Due to excellent platform compatibility, the cross-end container is used in production of many software applications. Due to differences in underlying mechanisms, the cross-end runtime environment is usually isolated from a native runtime environment on a terminal, and the two usually transmit data through a bridge module. However, the existing mode of transmitting data between the cross-end runtime environment and the native runtime environment is usually more time-consuming.

### SUMMARY

The embodiments of the present disclosure describe a method and apparatus for sharing data between a cross-end container and a native runtime environment, a device and a medium.

There is provided a method for sharing data between a cross-end container and a native runtime environment, in which the cross-end container and the native runtime environment run on a target terminal, and the method includes:
acquiring or updating, by the cross-end container or the native runtime environment, target data, and saving the target data to a shared storage region in the native runtime environment respectively in a first data format corresponding to the cross-end container and a second data format corresponding to the native runtime environment; and
accessing, by the native runtime environment or the cross-end container, the shared storage region, and reading the target data in the second data format or the first data format respectively corresponding to the native runtime environment or the cross-end container.

There is provided an apparatus for sharing data between a cross-end container and a native runtime environment, in which the cross-end container and the native runtime environment run on a target terminal, and the apparatus includes: a data acquiring unit and an accessing unit.

The data acquiring unit is configured to acquire or update, by the cross-end container or the native runtime environment, target data, and save the target data to a shared storage region in the native runtime environment respectively in a first data format corresponding to the cross-end container and a second data format corresponding to the native runtime environment.

The accessing unit is configured to access the shared storage region through the native runtime environment or the cross-end container, and read the target data in the second data format or the first data format respectively corresponding to the native runtime environment or the cross-end container.

There is provided a computer-readable storage medium, having a computer program stored thereon, in which the computer program when executed in a computer, causes the computer to execute the above method for sharing data between a cross-end container and a native runtime environment.

There is provided an electronic device, and the electronic device includes at least one memory and at least one processor, in which the at least one memory stores an executable code; and the at least one processor, when executing the executable code, implements the above method for sharing data between a cross-end container and a native runtime environment.

According to the embodiments of the present disclosure, there are provided a method and apparatus for sharing data between a cross-end container and a native runtime environment, a device and a medium. Firstly, the cross-end container or the native runtime environment acquires or updates target data, and saves the target data to a shared storage region in the native runtime environment respectively in a first data format corresponding to the cross-end container and a second data format corresponding to the native runtime environment. Then, the native runtime environment or the cross-end container accesses the shared storage region and reads the target data in the second data format or the first data format corresponding to the native runtime environment or the cross-end container. Through the method, time consumed for data format conversion during data transmission between both parties may be reduced, a data multiplex rate is improved, and the number of data requests to an external data source is reduced.

### BRIEF DESCRIPTION OF DRAWINGS

FIG. 1 shows a schematic diagram of data transmission between a cross-end container and a native runtime environment;

FIG. 2A shows a schematic diagram of a method for sharing data between a cross-end container and a native runtime environment according to an embodiment of the present disclosure;

FIG. 2B shows a schematic diagram of saving data in a shared storage region and reading data from the shared storage region according to an embodiment of the present disclosure;

FIG. 3 shows a schematic flow chart of a method for sharing data between a cross-end container and a native runtime environment according to an embodiment of the present disclosure;

FIG. 4 shows a schematic diagram of a shared storage region as a global singleton according to an embodiment of the present disclosure;

FIG. 5 shows a schematic block diagram of an apparatus for sharing data between a cross-end container and a native runtime environment according to an embodiment of the present disclosure;

FIG. 6 shows a structural schematic diagram of an electronic device suitable for implementing an embodiment of the present disclosure; and

FIG. 7 shows a structural schematic diagram of a storage medium suitable for implementing an embodiment of the present disclosure.

### DETAILED DESCRIPTION

The technical solution provided by this specification are further described in detail in conjunction with the accompanying drawings and embodiments. It may be understood that the specific embodiments described here are only intended to explain the relevant invention, and not to limit the invention. Furthermore, it should be noted that for ease of description, only the parts related to the relevant invention are shown in the accompanying drawings. It should be noted that, the embodiments of the present disclosure and the features in the embodiments may be combined with each other without conflicts.

In the description of the implementation of the present disclosure, the term ‘including” and similar terms shall be understood as open inclusion, that is, “including but not limited to”. The term “based on” should be understood as “at least partially based on”. The term “an/one implementation” or “the implementation” should be understood as “at least one implementation”. The term “some implementations” should be understood as “at least some implementations”. The following text may further include other explicit and implicit definitions.

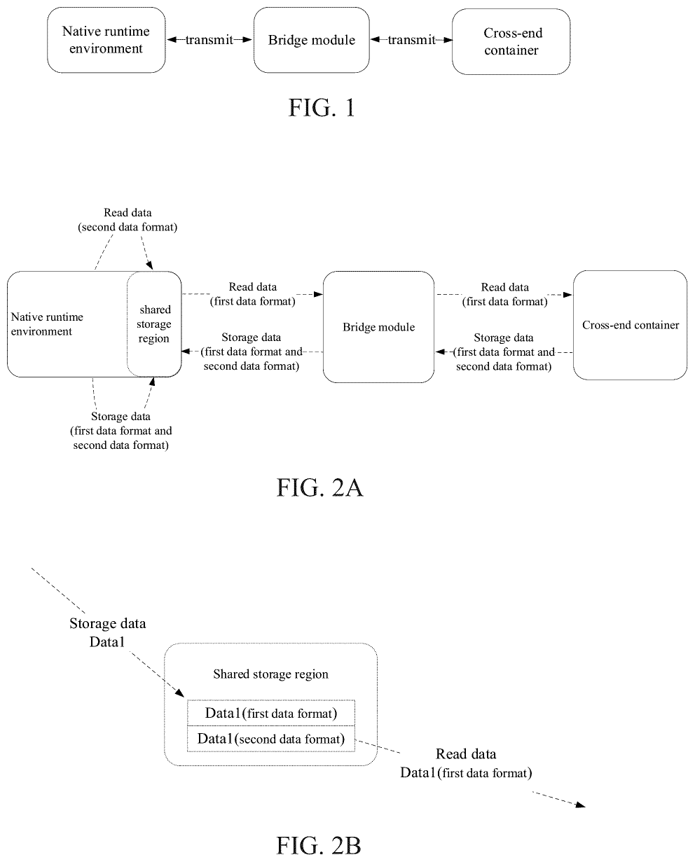

As described above, the cross-end container (the cross-end runtime environment) is a technology that allows the user to write a set of codes to run on a variety of terminals. Such technology provides a unified and standardized Application Programming Interface (API) for upper-level applications through capabilities of abstracting and encapsulating an underlying platform, to simplify a programming process of the user and improve software production efficiency. Due to excellent platform compatibility, the cross-end container is used in production of many software applications. Due to differences in underlying mechanisms, the cross-end runtime environment is usually isolated from the native runtime environment on the terminal, and the two may usually transmit data through the bridge module. The native runtime environment usually refers to an integrated environment of an operating system or a basic development platform on the terminal, through which applications may usually directly access underlying functions and resources of the operating system. FIG. 1 shows a schematic diagram of data transmission between the cross-end container and the native runtime environment. As shown in FIG. 1, the cross-end container and a native runtime environment running on the terminal may acquire each other's data through the bridge module.

However, directly using the bridge module to transmit data usually leads to transmission performance problems caused by data standardization. For example, the cross-end container uses data in one data format (e.g., Json format), while the native runtime environment uses data in another data format (e.g., class instance serialization format). Therefore, before transmitting data through the bridge module, format conversion needs to be performed, and the format conversion process will reduce a speed of data transmission. In addition, in actual runtime scenarios, the cross-end runtime environment and the native runtime environment usually request same data from a same data source; so repeated requests increase pressure on a data source server, and the process of repeated request per se increases total time consumed for dual-test data acquisition between the cross-end runtime environment and the native runtime environment.

To address the above-described technical problems, an embodiment of the present disclosure provides a method for sharing data between a cross-end container and a native runtime environment. FIG. 2A shows a schematic diagram of the method for sharing data between a cross-end container and a native runtime environment according to the embodiment of the present disclosure. As shown in FIG. 2A, in some embodiments, the cross-end container or the native runtime environment, may acquire or update data, and save the acquired or updated data to a shared storage region in the native runtime environment respectively in a data format corresponding to the cross-end container (e.g., a first data format) and a data format corresponding to the native runtime environment (e.g., a second data format). Then, the native runtime environment or the cross-end container may access the shared storage region and acquire data in a data format corresponding to its own environment. Specifically, in one example, as shown in FIG. 2B, for example, the native runtime environment may acquire data Data1 from an external data source and then save Data1 in a shared storage region in the native runtime environment respectively in a first data format and a second data format. Then, for example, when the cross-end container wants to use Data1, it may access the shared storage region to acquire Data1 in the first data format. In another example, for example, when the native runtime environment wants to use Data1, it may directly read Data1 in the first data format in the shared storage region. In other examples, the cross-end container may also acquire, for example, Data2, and then save Data2 to the shared storage region in the native runtime environment respectively in the first data format and the second data format, so that subsequently the native runtime environment or the cross-end container may directly read Data2 corresponding to its own environment from the shared storage region.

Advantages of this method rest in that: on the one hand, data transmission between the cross-end container and the native runtime environment may be completed through access to the shared storage space by both parties. In the process, conversion of the data format applicable to both parties is completed before each party saves data provided by its own to the shared storage space, so that both parties may directly read the saved data (for convenience of description, or simply referred to as data of the other party) without performing format conversion, which improves a speed of both parties reading data, and further increases a speed at which one party performs different tasks by utilizing data provided by the other party. In one example, for example, one party may utilize the data saved by the other party to improve a speed of loading its own page. On the other hand, for same data requested from a same data source, the frequency of data requests may be reduced through data multiplex, to further reduce pressure on the data source server, and reduce the total time consumed for dual-test data acquisition between the cross-end runtime environment and the native runtime environment.

Hereinafter, a detailed process of the method is further described below.

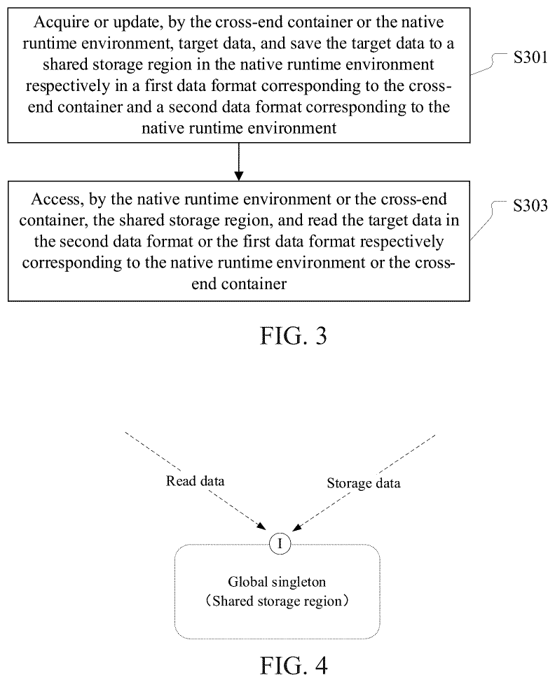

FIG. 3 shows a schematic flow chart of a method for sharing data between a cross-end container and a native runtime environment according to an embodiment of the present disclosure. The cross-end container and the native runtime environment run on a target terminal. As shown in FIG. 3, the method at least includes steps of:
Step S301, acquire or update, by the cross-end container or the native runtime environment, target data, and save the target data to a shared storage region in the native runtime environment respectively in a first data format corresponding to the cross-end container and a second data format corresponding to the native runtime environment.
Step S303, access, by the native runtime environment or the cross-end container, the shared storage region, and read the target data in the second data format or the first data format respectively corresponding to the native runtime environment or the cross-end container.

Firstly, in step S301, either of the cross-end container or the native runtime environment may acquire or update the target data, and save the target data to the shared storage region in the native runtime environment respectively in the first data format corresponding to the cross-end container and the second data format corresponding to the native runtime environment. In different embodiments, the target terminal may have different types of computer devices, which is not be limited in this specification. In one embodiment, for example, the target terminal may be a mobile terminal, specifically, for example, may be one of a mobile phone, a laptop, a portable android device, and a vehicle-mounted computer. In different embodiments, the cross-end container running on the target terminal may have different specific types of containers. Depending on operating systems or basic development platforms installed on different terminals, the native runtime environment running on the target terminal may also be different according to different embodiments. In different embodiments, the target data may also be of different specific types, or may also be data used in different specific businesses or purposes, which is not be limited in this specification. In one embodiment, the cross-end container and the native runtime environment, for example, may be called by a target program on the target terminal, and the target program may execute different tasks respectively through the cross-end container and the native runtime environment. For example, a cross-platform standardization task may be executed by the cross-end container, and a task that may access an underlying operating system resource or be efficiently executed locally may be executed by the native runtime environment.

As described above, data may be transmitted between the cross-end container and the native runtime environment through the bridge module. Therefore, in one embodiment, the cross-end container may save the target data to the shared storage region in the native runtime environment respectively in the first data format corresponding to the cross-end container and the second data format corresponding to the native runtime environment, through the bridge module configured to transmit data between the native runtime environment and the cross-end container, as shown in FIG. 2. In different specific embodiments, the cross-end container may save the target data to the shared storage region in the native runtime environment through different specific types of bridge modules. In a specific embodiment, for example, the target data may be saved to the shared storage region in the native runtime environment through a JavaScript Bridge (JSBridge).

In different embodiments, the data sources from which the cross-end container or the native runtime environment acquires or updates the target data may be different. In one embodiment, the cross-end container or the native runtime environment may acquire the target data from an external data source. Thus, the acquired external data may be saved to the shared storage region in the native runtime environment respectively in the first data format and the second data format. In this embodiment, the external data saved to the shared storage region may be multiplexed by the cross-end container and the native runtime environment in a subsequent step, to reduce the number of data requests to the external data source, and to further reduce pressure on the external data source server and reduce the total time consumed for data requests.

In another embodiment, the cross-end container or the native runtime environment may further update the target data inside the cross-end container or the native runtime environment. Thus, their internal data may be saved to the shared storage region in the native runtime environment respectively in the first data format and the second data format. In this embodiment, when multiplexing data saved to the shared storage region in a subsequent step, the cross-end container or the native runtime environment may also directly read data in a data format matching its own environment without format conversion, which further improves a speed of data reading.

In different embodiments, the shared storage region may be set in different modes. In one embodiment, the shared storage region may be set as a global single object instance, or simply referred to as a global singleton. The global singleton may be a globally unique program object in a program or an application, and may be accessed globally. In a specific embodiment, the global single object instance may include a predetermined data access interface. Further, the cross-end container or the native runtime environment may save the target data to the global single object instance respectively in the first data format and the second data format through the data access interface; and read the target data in the second data format or the first data format from the global single object instance through the data access interface, as shown in FIG. 4. By saving the data through the global single object instance, the data may be conveniently accessed globally in a runtime environment, and the cross-end container may also conveniently access the data through the bridge module.

In order to further facilitate saving and reading different data in the shared storage region, in a specific embodiment, the target data may also be saved to a storage unit corresponding to an identifier in the shared storage region in the first data format and the second data format according to the identifier corresponding to the target data. Further, when subsequently the native runtime environment or the cross-end container accesses the shared storage region, the target data in a data format matching the environment of the native runtime environment or the cross-end container may be read from the storage unit corresponding to the identifier, according to the identifier of the target data.

In different embodiments, the first data format and the second data format may also respectively be different specific formats depending on the cross-end container and the native runtime environment, which is not be limited in this specification. In one embodiment, the first data format, for example, may be a Json format, and the second data format, for example, may be a class instance serialization format.

Then, in step S303, the native runtime environment or the cross-end container accesses the shared storage region and reads the target data in the second data format or the first data format corresponding to the native runtime environment or the cross-end container. In the step, the native runtime environment or the cross-end container may directly read the target data in a data format matching its own environment from the shared storage region.

In the above-described embodiment that either the cross-end container or the native runtime environment acquires the target data from the external data source and saves to the shared storage region, in the step, both the cross-end container and the native runtime environment may multiplex the target data saved in the shared storage region, without requesting data from the external data source, thereby reducing overall frequency and time consumption of data requests. In addition, processing pressure on the data source server and transmission pressure on the network may also be reduced.

In the above-described embodiment that either the cross-end container or the native runtime environment updates the internal target data and save to the shared storage region, in the step, both the cross-end container and the native runtime environment may directly read the target data of a data format matching its own environment saved in the shared storage region without format conversion, which improves the speed of data reading.

In the above-described embodiment that the cross-end container reads the target data, the cross-end container may access the shared storage region through the bridge module and read the target data in the first data format.

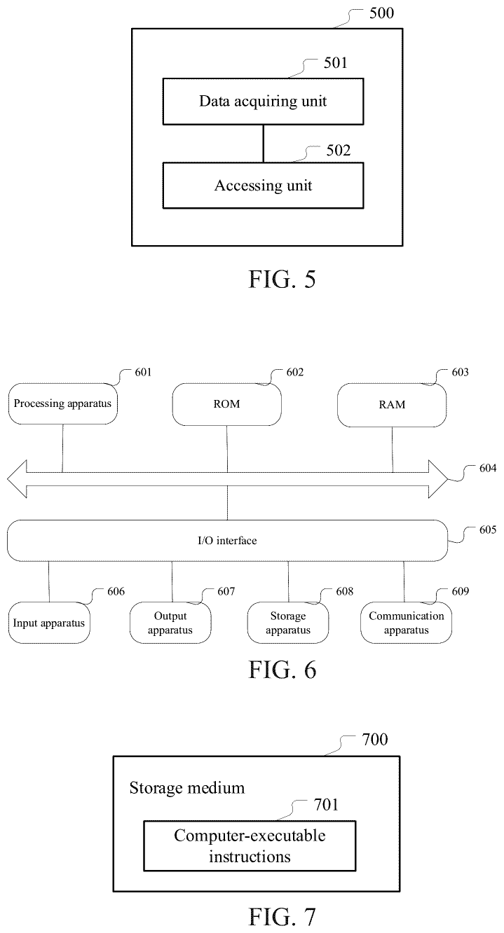

FIG. 5 shows a schematic block diagram of an apparatus for sharing data between a cross-end container and a native runtime environment according to an embodiment of the present disclosure. The apparatus is configured to execute the method shown in FIG. 3; and the cross-end container and the native runtime environment run on the target terminal. As shown in FIG. 5, the apparatus 500 includes: a data acquiring unit 501 and an accessing unit 502.

The data acquiring unit 501 is configured to acquire or update, by the cross-end container or the native runtime environment, target data, and save the target data to a shared storage region in the native runtime environment respectively in a first data format corresponding to the cross-end container and a second data format corresponding to the native runtime environment.

The accessing unit 502 is configured to access the shared storage region through the native runtime environment or the cross-end container, and read the target data in the second data format or the first data format respectively corresponding to the native runtime environment or the cross-end container.

An embodiment of the present disclosure further provides an electronic device, including a memory and a processor, in which the memory stores an executable code; and the processor, when executing the executable code, implements the method shown in FIG. 3.

Hereinafter, referring to FIG. 6, it shows a structural schematic diagram of an electronic device 600 suitable for implementing the embodiment of the present disclosure. The electronic device 600 shown in FIG. 6 is only an example and should not impose any limitations on the functionality and scope of use of the embodiment of the present disclosure.

As shown in FIG. 6, the electronic device 600 may include a processing apparatus (e.g., a central processing unit, a graphics processor, etc.) 601. The above-described processing apparatus 601 may be a general-purpose processor, a digital signal processing (DSP), a microprocessor or a microcontroller, and may further include an application specific integrated circuit (ASIC), a field-programmable gate array (FPGA) or other programmable logic devices, discrete gates or transistor logic devices, discrete hardware components, which may executes various appropriate actions and processing according to a program stored in a read-only memory (ROM) 602 or a program loaded from a storage apparatus 608 into a random access memory (RAM) 603. The RAM 603 further stores various programs and data required for operation of the electronic device 600. The processing apparatus 601, the ROM 602, and the RAM 603 are connected with each other through a bus 604. An input/output (I/O) interface 605 is also coupled to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 6 illustrates the electronic device 600 having various apparatuses, it should be understood that not all of the illustrated apparatuses are necessarily implemented or included. More or fewer apparatuses may be implemented or included alternatively. Each box shown in FIG. 6 may represent one apparatus, or may also represent a plurality of apparatuses as needed.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the method for sharing data between a cross-end container and a native runtime environment provided by embodiments of the present disclosure are performed.

An embodiment of the present disclosure further provides a computer-readable storage medium, having a computer program stored thereon, in which the computer program, when executed in the computer, causes the computer to execute the method for sharing data between a cross-end container and a native runtime environment as shown in FIG. 3 provided by the embodiment of the present disclosure. FIG. 7 is a schematic diagram of a storage medium for implementing the embodiment of the present disclosure. For example, as shown in FIG. 7, the storage medium 700 may be a non-temporary computer-readable storage medium, configured to store non-temporary computer-executable instructions 701. The non-temporary computer-executable instructions 701, when executed by a processor, may implement the method for sharing data between a cross-end container and a native runtime environment provided by the embodiment of the present disclosure, for example, the non-temporary computer-executable instructions 701, when executed by the processor, may execute one or more steps of the method for sharing data between a cross-end container and a native runtime environment provided by the embodiment of the present disclosure. For example, the storage medium 700 may be applied to the above-described electronic device, for example, the storage medium 700 may include a memory in the electronic device. The description of the memory in the embodiment of the electronic device may be referred to for the description of the storage medium 700, and no details repeated here. The description of the method for sharing data between a cross-end container and a native runtime environment provided by the embodiment of the present disclosure may be referred to for specific functions and technical effects of the storage medium 700, and no details repeated here.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include, but are not limited to: an electrical connection having one or more conductors, a storage card of a smartphone, a storage component of a portable android device, a portable computer diskette, a hard drive of a personal computer, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In embodiments of the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device. The above-mentioned computer-readable medium carries one or more programs, and when the one or more programs are executed by the electronic device, the electronic device is caused to implementing the method for sharing data between a cross-end container and a native runtime environment as provided by embodiments of the present application.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions. The modules or units involved in the embodiments of the present disclosure may be implemented in software or hardware. Among them, the name of the module or unit does not constitute a limitation of the unit itself under certain circumstances. The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

Each of the embodiments in this specification are described in a progressive manner, same or similar parts among the respective embodiments may be referred to each other; each embodiment focuses on difference from other embodiments. In particular, with respect to the storage medium and the computing device embodiment, since it is basically similar to the method embodiment, description thereof is relatively simple, and description of the parts of the method embodiment may be referred to for the related parts.

The above description is merely description of some preferred embodiments of the present disclosure and technical principles applied thereto. Those skilled in the art should understand that, the scope of disclosure involved in the present disclosure is not limited to the technical solution formed by the specific combination of the above-described technical features, and should also cover, without departing from the above-described inventive concept, other technical solutions formed by any combination of the above-described technical features or equivalent features thereof, for example, a technical solution formed by mutually replacing the above-described features with the technical features disclosed (but not limited to) in the present disclosure with similar functions. Furthermore, although the respective operations are described in a particular order, this should not be understood as requiring the operations to be executed in the particular order shown or in a sequential order. Under certain circumstances, multitasking and parallel processing may be favorable. Similarly, although the above discussion includes a number of specific implementation details, these should not be interpreted as limiting the scope of the present disclosure. Certain features as described in the context of separate embodiments may also be implemented in a single embodiment in combination. Conversely, various features as described in the context of a single embodiment may also be implemented in a plurality of embodiments individually or in any suitable sub-combination.

The purpose, technical solutions and advantageous effects of the embodiments of the present disclosure are further explained in detail in the specific implementations as described above. Although the subject matter has been described in terms specific to the structural features and/or method logic actions, it should be understood that the subject matter defined in the appended claims is not necessarily limited to the specific features or actions as described above. On the contrary, the specific features and actions as described above are only examples of implementing the claims. It should be understood that the foregoing embodiments merely are specific implementations of the present disclosure, and not intended to limit the protection scope of the present disclosure. Any modification, equivalent substitution, improvement, and the like, made on the basis of the technical solution of the present disclosure should be covered within the protection scope of the present disclosure.

1. A method for sharing data between a cross-end container and a native runtime environment, wherein the cross-end container and the native runtime environment run on a target terminal, and the method comprises:
acquiring or updating, by the cross-end container or the native runtime environment, target data, and saving the target data to a shared storage region in the native runtime environment respectively in a first data format corresponding to the cross-end container and a second data format corresponding to the native runtime environment; and
accessing, by the native runtime environment or the cross-end container, the shared storage region, and reading the target data in the second data format or the first data format respectively corresponding to the native runtime environment or the cross-end container.

2. The method according to claim 1, wherein acquiring or updating, by the cross-end container or the native runtime environment, target data, and saving the target data to a shared storage region in the native runtime environment respectively in a first data format corresponding to the cross-end container and a second data format corresponding to the native runtime environment, comprises:
saving, by the cross-end container, the target data to the shared storage region in the native runtime environment respectively in the first data format and the second data format, through a bridge module configured to transmit data between the native runtime environment and the cross-end container;
accessing, by the native runtime environment or the cross-end container, the shared storage region, and reading the target data in the second data format or the first data format respectively corresponding to the native runtime environment or the cross-end container, comprises:
accessing, by the cross-end container, the shared storage region through the bridge module, and reading the target data in the first data format.

3. The method according to claim 1, wherein acquiring or updating, by the cross-end container or the native runtime environment, target data, comprises:
acquiring, by the cross-end container or the native runtime environment, the target data from an external data source.

4. The method according to claim 1, wherein acquiring or updating, by the cross-end container or the native runtime environment, target data, comprises:
updating, by the cross-end container or the native runtime environment, the target data inside the cross-end container or the native runtime environment.

5. The method according to claim 1, the shared storage region comprises a global single object instance.

6. The method according to claim 5, wherein the global single object instance comprises a predetermined data access interface;
the saving the target data to a shared storage region in the native runtime environment respectively in a first data format corresponding to the cross-end container and a second data format corresponding to the native runtime environment, comprises:
saving, by the cross-end container or the native runtime environment, the target data to the global single object instance respectively in the first data format and the second data format through the data access interface;
accessing, by the native runtime environment or the cross-end container, the shared storage region, and reading the target data in the second data format or the first data format respectively corresponding to the native runtime environment or the cross-end container, comprises:
reading, by the native runtime environment or the cross-end container, the target data in the second data format or the first data format from the global single object instance through the data access interface.

7. The method according to claim 1, wherein the saving the target data to a shared storage region in the native runtime environment respectively in a first data format corresponding to the cross-end container and a second data format corresponding to the native runtime environment, comprises:
saving the target data to a storage unit corresponding to an identifier corresponding to the target data in the shared storage region in the first data format and the second data format, according to the identifier;
the reading the target data in the second data format or the first data format respectively corresponding to the native runtime environment or the cross-end container, comprises:
reading the target data in the second data format or the first data format from the storage unit corresponding to the identifier in the shared storage region.

8. The method according to claim 1, wherein the first data format is a Json format, and the second data format is a class instance serialization format.

9. A non-transitory computer-readable storage medium, having a computer program stored thereon, wherein the computer program when executed in a computer, causes the computer to execute a method for sharing data between a cross-end container and a native runtime environment, wherein the cross-end container and the native runtime environment run on a target terminal, and the method comprises:
acquiring or updating, by the cross-end container or the native runtime environment, target data, and saving the target data to a shared storage region in the native runtime environment respectively in a first data format corresponding to the cross-end container and a second data format corresponding to the native runtime environment; and
accessing, by the native runtime environment or the cross-end container, the shared storage region, and reading the target data in the second data format or the first data format respectively corresponding to the native runtime environment or the cross-end container.

10. The non-transitory computer-readable storage medium according to claim 9, wherein acquiring or updating, by the cross-end container or the native runtime environment, target data, and saving the target data to a shared storage region in the native runtime environment respectively in a first data format corresponding to the cross-end container and a second data format corresponding to the native runtime environment, comprises:
saving, by the cross-end container, the target data to the shared storage region in the native runtime environment respectively in the first data format and the second data format, through a bridge module configured to transmit data between the native runtime environment and the cross-end container;
accessing, by the native runtime environment or the cross-end container, the shared storage region, and reading the target data in the second data format or the first data format respectively corresponding to the native runtime environment or the cross-end container, comprises:
accessing, by the cross-end container, the shared storage region through the bridge module, and reading the target data in the first data format.

11. The non-transitory computer-readable storage medium according to claim 9, wherein acquiring or updating, by the cross-end container or the native runtime environment, target data, comprises:
acquiring, by the cross-end container or the native runtime environment, the target data from an external data source.

12. The non-transitory computer-readable storage medium according to claim 9, wherein acquiring or updating, by the cross-end container or the native runtime environment, target data, comprises:
updating, by the cross-end container or the native runtime environment, the target data inside the cross-end container or the native runtime environment.

13. An electronic device, comprising at least one memory and at least one processor, wherein the at least one memory stores an executable code; and the at least one processor, when executing the executable code, implements a method for sharing data between a cross-end container and a native runtime environment, wherein the cross-end container and the native runtime environment run on a target terminal, and the method comprises:
acquiring or updating, by the cross-end container or the native runtime environment, target data, and saving the target data to a shared storage region in the native runtime environment respectively in a first data format corresponding to the cross-end container and a second data format corresponding to the native runtime environment; and
accessing, by the native runtime environment or the cross-end container, the shared storage region, and reading the target data in the second data format or the first data format respectively corresponding to the native runtime environment or the cross-end container.

14. The electronic device according to claim 13, wherein acquiring or updating, by the cross-end container or the native runtime environment, target data, and saving the target data to a shared storage region in the native runtime environment respectively in a first data format corresponding to the cross-end container and a second data format corresponding to the native runtime environment, comprises:
saving, by the cross-end container, the target data to the shared storage region in the native runtime environment respectively in the first data format and the second data format, through a bridge module configured to transmit data between the native runtime environment and the cross-end container;
accessing, by the native runtime environment or the cross-end container, the shared storage region, and reading the target data in the second data format or the first data format respectively corresponding to the native runtime environment or the cross-end container, comprises:
accessing, by the cross-end container, the shared storage region through the bridge module, and reading the target data in the first data format.

15. The electronic device according to claim 13, wherein acquiring or updating, by the cross-end container or the native runtime environment, target data, comprises:
acquiring, by the cross-end container or the native runtime environment, the target data from an external data source.

16. The electronic device according to claim 13, wherein acquiring or updating, by the cross-end container or the native runtime environment, target data, comprises:
updating, by the cross-end container or the native runtime environment, the target data inside the cross-end container or the native runtime environment.

17. The electronic device according to claim 13, the shared storage region comprises a global single object instance.

18. The electronic device according to claim 17, wherein the global single object instance comprises a predetermined data access interface;
the saving the target data to a shared storage region in the native runtime environment respectively in a first data format corresponding to the cross-end container and a second data format corresponding to the native runtime environment, comprises:
saving, by the cross-end container or the native runtime environment, the target data to the global single object instance respectively in the first data format and the second data format through the data access interface;
accessing, by the native runtime environment or the cross-end container, the shared storage region, and reading the target data in the second data format or the first data format respectively corresponding to the native runtime environment or the cross-end container, comprises:
reading, by the native runtime environment or the cross-end container, the target data in the second data format or the first data format from the global single object instance through the data access interface.

19. The electronic device according to claim 13, wherein the saving the target data to a shared storage region in the native runtime environment respectively in a first data format corresponding to the cross-end container and a second data format corresponding to the native runtime environment, comprises:
saving the target data to a storage unit corresponding to an identifier corresponding to the target data in the shared storage region in the first data format and the second data format, according to the identifier;
the reading the target data in the second data format or the first data format respectively corresponding to the native runtime environment or the cross-end container, comprises:
reading the target data in the second data format or the first data format from the storage unit corresponding to the identifier in the shared storage region.

20. The method according to claim 13, wherein the first data format is a Json format, and the second data format is a class instance serialization format.
